(19) United States
(12) Patent Application Publication
(10) Pub. No.: US 2025/0122085 A1
(43) Pub. Date: Apr. 17, 2025

(54) System And Method For Making Ammonia From Plastic

(71) Applicant: Plastic 2 Green Inc., Loveland, CO (US)

(72) Inventor: Edward VanDyne, Loveland, CO (US)

(73) Assignee: Plastic 2 Green Inc., Loveland, CO (US)

(21) Appl. No.: 18/911,996

(22) Filed: Oct. 10, 2024

Related U.S. Application Data
(60) Provisional application No. 63/543,594, filed on Oct. 11, 2023.

(51) Int. Cl. C01C 1/04; C01B 3/50; C01C 1/00

(52) U.S. Cl. CPC C01C 1/0405; C01B 3/50; C01C 1/003; C01C 1/0494

(57) ABSTRACT

A system and method for making ammonia from plastic, whereby the method includes heating the plastic comprising hydrocarbons to gasify the hydrocarbons and generate gaseous hydrocarbons comprising hydrogen and carbon, heating the gaseous hydrocarbons to separate the hydrogen and the carbon and generate heated hydrogen, and combining the heated hydrogen with nitrogen to generate ammonia.

### I. SUMMARY OF THE INVENTION

A broad object of a particular embodiment of the invention can be to provide a system and method for making ammonia from plastic, whereby the method includes heating the plastic comprising hydrocarbons to gasify the hydrocarbons and generate gaseous hydrocarbons comprising hydrogen and carbon, heating the gaseous hydrocarbons to separate the hydrogen and the carbon and generate heated hydrogen, and combining the heated hydrogen with nitrogen to generate ammonia.

Naturally, further objects of the invention are disclosed throughout other areas of the specification, drawings, and claims.

### II. BRIEF DESCRIPTION OF THE DRAWINGS

FIG. 1 is an illustration of a particular embodiment of the present method of making ammonia from plastic.

FIG. 2 is an illustration of another particular embodiment of the present method of making ammonia from plastic.

FIG. 3 is an illustration of another particular embodiment of the present method of making ammonia from plastic.

FIG. 4 is an illustration of a plasma torch and corresponding electric arc which may be useful with a particular embodiment of the present method of making ammonia from plastic to chemically separate hydrogen and carbon and generate heated hydrogen.

FIG. 5 is an illustration of another particular embodiment of the present method of making ammonia from plastic.

### III. DETAILED DESCRIPTION OF THE PREFERRED EMBODIMENTS

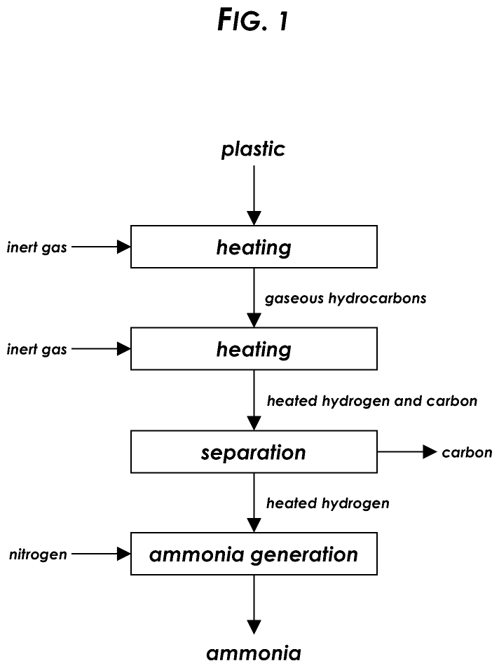

Now referring primarily to FIG. 1 which illustrates a system and method for making ammonia from plastic in accordance with the present invention, whereby the method includes heating the plastic comprising hydrocarbons to gasify the hydrocarbons and generate gaseous hydrocarbons comprising hydrogen and carbon, heating the gaseous hydrocarbons to separate, such as electrothermally separate, the hydrogen and the carbon and generate heated hydrogen, and combining the heated hydrogen with nitrogen to generate ammonia.

To make ammonia, the present invention employs plastic. As used here, the term “plastic” means a polymeric material that has the capability of being molded or shaped when soft and/or in a liquid state, such as by the application of heat and/or pressure, and then hardened to retain the given shape. Plastic can be made from synthetic and/or natural polymers; some polymers may be hydrocarbons which contain only carbon and hydrogen, while other polymers may be hydrocarbon-based and additionally contain oxygen, chlorine, fluorine, nitrogen, silicon, phosphorus, sulfur, etc. As used herein, the term “hydrocarbon” includes both types of polymers. Plastics useful with the present invention can include, but are not limited to, polyethylene terephthalate (PET or PETE, (C₁₀H₈O₄)ₙ), polymethyl methacrylate (PMMA, (C₅H₈O₂)ₙ), polyethylene (PE, (C₂H₄)ₙ), low-density polyethylene (LDPE), high-density polyethylene (HDPE), polyvinyl chloride (PVC, (C₂H₃Cl)ₙ), polypropylene (PP, (C₃H₆)ₙ), and polystyrene (PS, (C₈H₈)ₙ).

Typically, plastics are considered nonbiodegradable, meaning these materials cannot be broken down by the action of living organisms. Under normal environmental conditions, most plastics do not degrade for an average of 300 years, thus polluting the environment with plastic waste. As used herein, the term “waste” means discarded and considered no longer useful. In the United States, it is estimated that plastic waste totals 99.5 million tons per year, with only 8% to 9% being recycled and the remainder being disposed of via incineration and landfilling. Further, it is estimated that there are over 150 million metric tons of plastic waste in the oceans.

Correspondingly, there is a need for a method which can break down plastic waste (including post-consumer plastic waste, post-industrial plastic waste, etc.), preferably without emitting carbon dioxide (CO₂), and upcycle the constituent components and in particular, hydrogen. Conventionally, hydrogen, “the fuel of the future,” is produced commercially via steam methane reforming (SMR), which involves reacting natural gas (methane, CH₄) with high-temperature steam (H₂O) in the presence of a catalyst to produce hydrogen gas (H₂) and carbon monoxide (CO) as well as carbon dioxide (CO₂) and potentially methane (CH₄). In addition to carbon emissions, SMR can release other pollutants into the atmosphere, including nitrogen oxides (NOx), which may contribute to smog and acid rain. Further, the production of hydrogen via SMR requires a significant amount of water (used in the form of steam), and is an energy-intensive process. As a result of the foregoing, significant pollution and environmental impacts are associated with SMR.

In the subsequent description, for the sake of simplicity and brevity, the term “plastic” will be used and refers primarily to plastic waste, although non-waste plastic may also be processed via the present method.

In addition to plastic, the present method can also be utilized for upcycling other materials which include constituent hydrogen, such as paper products (comprising cellulose/carbohydrates), biomass, etc.

The present method can be considered “chemical” recycling, which differs from “mechanical” recycling. The latter typically refers to a recycling process that includes a step of melting plastic and forming the molten plastic into a new intermediate product (e.g., pellets or sheets) and/or a new end product (e.g., bottles). Generally, mechanical recycling does not substantially change the chemical structure of the plastic being recycled.

For the present method, the plastic feedstock (input plastic) can be mixed (or unsorted), whereby “mixed” plastic means a mixture of at least two types of plastic including, but not limited to, the following types of plastic: PET, PE, LDPE, HDPE, PVC, PP, and PS. Advantageously, for the present method, the plastic feedstock can be clean or unwashed, and/or with or without pretreatment. Further, as to particular embodiments, the plastic feedstock can be “contaminated,” such as with paper, water, biomass, food waste, glass, metal, dirt, sand, other plastics, etc. Hydrogen from any “contaminants” can also be upcycled via the present method.

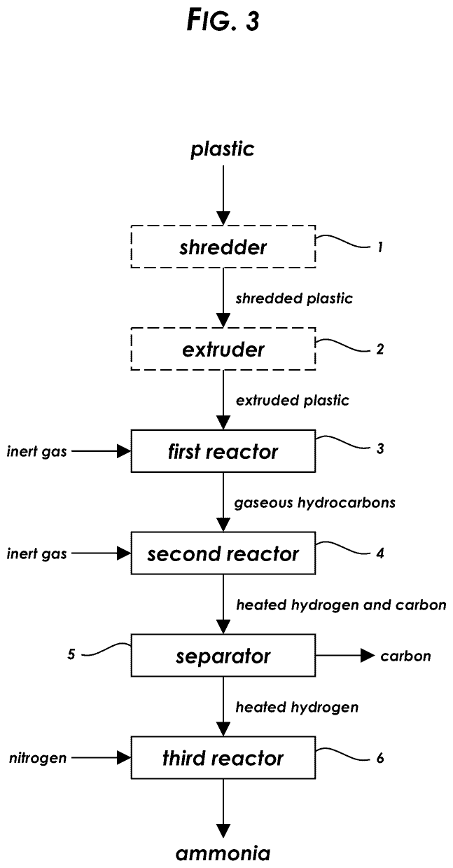

Now referring primarily to FIG. 3, as to particular embodiments, for the present method, the plastic components of the feedstock can, but need not necessarily, be (mechanically) reduced in size prior to heating the plastic to gasify the hydrocarbons, such as via cutting up the plastic components into smaller pieces and/or shredding the plastic components, for example by means of a shredder (1), to generate shredded plastic. The shredder (1) can comprise any conventional shredder known in the art and/or in the literature that generally reduces the size of the plastic components in one or more steps to generate smaller pieces. As an illustrative example, an intact plastic bottle can be shredded into shredded plastic pieces having a length of about 1 inch. Of course, other shredded plastic piece sizes are herein contemplated, depending upon the embodiment. By reducing the size of the plastic components of the feedstock prior to heating the plastic to gasify the hydrocarbons, the volume of the bulk plastic feedstock can be reduced, the volume of the individual plastic components constituting the bulk plastic feedstock can be reduced, and/or the amount of air (and correspondingly oxygen) within said volumes can be reduced. In addition to shredding, the plastic components of the feedstock can be reduced in size prior to heating the plastic to gasify the hydrocarbons by other means which may result in pelleted plastic, flaked plastic, granulated plastic, powdered plastic, or the like. Shredding of the input material into smaller pieces can result in a more efficient, less energy usage process in the first reactor (3).

Again referring primarily to FIG. 3, as to particular embodiments, for the present method, the shredded plastic can, but need not necessarily, be compacted or compressed prior to heating the plastic to gasify the hydrocarbons, such as via extruding the shredded plastic, for example by means of an extruder (2), thus melting at least a portion of the shredded plastic (such as the plastic types within the shredded mixed plastic having a lower melting temperature) and forming it into a continuous profile to provide extruded plastic. Typically, the melted plastic can be forced into a die to shape the continuous profile and provide the extruded plastic. The extruder (2) can comprise any conventional extruder known in the art and/or in the literature that generally compacts or compresses the shredded plastic in one or more steps to generate extruded plastic. By compacting or compressing the shredded plastic feedstock prior to gasification of the hydrocarbons, the volume of the shredded plastic feedstock can be reduced, and/or the amount of air (and correspondingly oxygen) within said volume can be reduced.

Now referring primarily to FIGS. 1 through 3, the present method includes heating plastic comprising hydrocarbons to gasify the hydrocarbons, thereby generating gaseous hydrocarbons. Additional byproducts may also be generated, depending upon the composition of the plastic feedstock, but for the sake of simplicity and brevity, are not presently discussed. As used herein, the term “gasify” (and its derivatives) simply means to convert to a gas or vapor, whereby the composition can be gaseous under the operating conditions (such as temperature and pressure) of the chamber in which it is present.

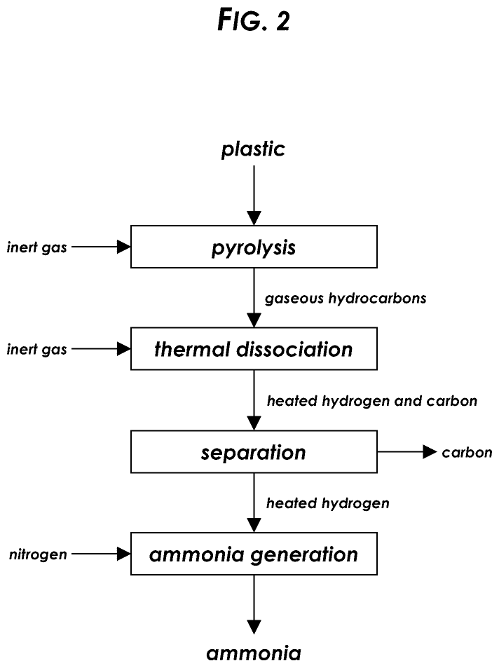

Now referring primarily to FIG. 2, as to particular embodiments, heating the plastic to gasify the hydrocarbons can be accomplished via pyrolysis, which may be defined as the decomposition of a material via heating to a high temperature, often in the absence (or substantial absence) of oxygen. Thus, the method can include pyrolyzing plastic or subjecting plastic to pyrolysis which, instead of burning, can depolymerize or “crack” the polymerized hydrocarbons by breaking bonds within larger and/or more complex molecules to generate smaller and/or less complex molecules and/or atoms.

Now referring primarily to FIG. 3, the present method can include introducing a feedstock comprising, consisting essentially of, or consisting of plastic (such as but not necessarily extruded plastic feedstock) via one or more inlets into a first reactor (3) in which the plastic can undergo a pyrolysis reaction or be pyrolyzed. Although pyrolysis processes may be generally characterized as thermally-induced chemical decomposition reactions in an environment that is substantially free of oxygen, said processes can be further defined by other parameters such as the operating temperature of the reactor, the operating pressure of the reactor, the presence or absence of a catalyst(s) in the reactor, the reactor type, etc.

As alluded to above, the first reactor (3) can be gastight and the environment therewithin (in which the pyrolysis reaction takes place) can be substantially free of oxygen or can contain less oxygen relative to ambient air. For example, the environment within the first reactor (3) can comprise not more than 20% oxygen by weight, not more than 17.5% oxygen by weight, not more than 15% oxygen by weight, not more than 12.5% oxygen by weight, not more than 10% oxygen by weight, not more than 7.5% oxygen by weight, not more than 5% oxygen by weight, not more than 2.5% oxygen by weight, or not more than 1% oxygen by weight, depending upon the embodiment. As to particular embodiments, a portion or the majority of the weight percent of oxygen within the environment of the first reactor (3) can originate from plastic feedstock contaminants such as water, cellulose/carbohydrates, plastic colorants, etc.

Of note, as the first reactor (3) can be substantially free of oxygen, there may be minimal or no combustion process(es) occurring therewithin to produce the pollutants normally expected from incinerators, such as greenhouse gases (which refer to gases in the Earth's atmosphere that absorb and trap heat). Examples of greenhouse gases include, but are not limited to, carbon dioxide (CO₂), methane (CH₄), nitrous oxide (N₂O), and ozone (O₃), as well as many halogenated compounds.

As to particular embodiments, the environment within the gastight first reactor (3) can comprise primarily one or more inert gases, such as nitrogen, argon, helium, any gas that does not comprise oxygen, or any non-oxygen-carrying gas. As to particular embodiments, the environment within the gastight first reactor (3) can comprise primarily inert gas. For example, the environment within the first reactor (3) can comprise not less than 100% inert gas by weight, not less than 99% inert gas by weight, not less than 95% inert gas by weight, not less than 90% inert gas by weight, not less than 85% inert gas by weight, not less than 80% inert gas by weight, not less than 75% inert gas by weight, not less than 70% inert gas by weight, not less than 65% inert gas by weight, not less than 60% inert gas by weight, not less than 55% inert gas by weight, not less than 50% inert gas by weight, not less than 45% inert gas by weight, not less than 40% inert gas by weight, not less than 35% inert gas by weight, not less than 30% inert gas by weight, not less than 25% inert gas by weight, not less than 20% inert gas by weight, not less than 15% inert gas by weight, not less than 10% inert gas by weight, not less than 5% inert gas by weight, not less than 1% inert gas by weight, or 0% inert gas by weight, depending upon the embodiment. The inert gas can be fed into the first reactor (3) via an inert gas inlet. As to particular embodiments, the inert gas inlet can be fluidically coupled to an inert gas source. As to particular embodiments including nitrogen as an inert gas, the inert gas inlet can be fluidically coupled to a nitrogen tank, which can be supplied by a nitrogen generator that can separate nitrogen gas from atmospheric air.

As to particular embodiments, the pyrolysis reaction performed in the first reactor (3) can be carried out at a temperature of between about 300 degrees Celsius (° C.) and about 1,250° C. As to particular embodiments, the pyrolysis reaction performed in the first reactor (3) can be carried out at a temperature of between about 400° C. and about 1,000° C. As to particular embodiments, the pyrolysis reaction performed in the first reactor (3) can be carried out at a temperature of not less than about 300° C., not less than about 400° C., not less than about 500° C., not less than about 600° C., not less than about 700° C., not less than about 800° C., not less than about 900° C., not less than about 1,000° C., not less than about 1,100° C., not less than about 1,200° C., or not less than about 1,250° C., depending upon the embodiment. As to particular embodiments, the pyrolysis reaction performed in the first reactor (3) can be carried out at a temperature of not greater than about 400° C., not greater than about 500° C., not greater than about 600° C., not greater than about 700° C., not greater than about 800° C., not greater than about 900° C., or not greater than about 1,000° C., depending upon the embodiment. Naturally, the temperature can be adjusted to facilitate the production of a desired end product(s).

As to particular embodiments, the pyrolysis reaction performed in the first reactor (3) can be carried out at an operating pressure of between about 0 pounds per square inch (psi) and about 750 psi. As to particular embodiments, the pyrolysis reaction performed in the first reactor (3) can be carried out at an operating pressure of between about 0 psi and about 150 psi. As to particular embodiments, the pyrolysis reaction performed in the first reactor (3) can be carried out at an operating pressure of between about 37.5 psi and about 250 psi. As to particular embodiments, the pyrolysis reaction performed in the first reactor (3) can be carried out at an operating pressure of between about 50 psi and about 200 psi. As to particular embodiments, the pyrolysis reaction performed in the first reactor (3) can be carried out at an operating pressure of between about 112.5 psi and about 750 psi. As to particular embodiments, the pyrolysis reaction performed in the first reactor (3) can be carried out at an operating pressure of between about 150 psi and about 600 psi.

As to particular embodiments, the pyrolysis reaction performed in the first reactor (3) can be carried out at an operating pressure of not less than about 0 psi, not less than about 37.5 psi, not less than about 50 psi, not less than about 100 psi, not less than about 150 psi, not less than about 200 psi, not less than about 250 psi, not less than about 300 psi, not less than about 350 psi, not less than about 400 psi, not less than about 450 psi, not less than about 500 psi, not less than about 550 psi, not less than about 600 psi, not less than about 650 psi, not less than about 700 psi, or not less than about 750 psi, depending upon the embodiment. As to particular embodiments, the pyrolysis reaction performed in the first reactor (3) can be carried out at an operating pressure of not greater than about 0 psi, not greater than about 37.5 psi, not greater than about 50 psi, not greater than about 100 psi, not greater than about 150 psi, not greater than about 200 psi, not greater than about 250 psi, not greater than about 300 psi, not greater than about 350 psi, not greater than about 400 psi, not greater than about 450 psi, not greater than about 500 psi, not greater than about 550 psi, not greater than about 600 psi, not greater than about 650 psi, not greater than about 700 psi, or not greater than about 750 psi, depending upon the embodiment. Naturally, the pressure can be adjusted to facilitate the production of a desired end product(s). As to particular embodiments, the pressure within the first reactor (3) can function, at least in part, to keep air out of the first reactor (3) and/or generate a pressure gradient to transfer the gaseous hydrocarbons into a subsequent process component(s), such as a second reactor (4). Of note, plastic gasification as well as the gasification of contaminants (such as water, etc.) can generate pressure; thus, the pressure within the first reactor (3) can vary depending upon the type of plastic feedstock and/or the amount of contaminants present.

As to particular embodiments, the pyrolysis reaction performed in the first reactor (3) can be carried out in the absence of a catalyst. As to other particular embodiments, the pyrolysis reaction performed in the first reactor (3) can be carried out in the presence of a catalyst.

Various pyrolytic processes can be used with the present invention, including but not limited to, slow pyrolysis, fast pyrolysis, flash pyrolysis, microwave pyrolysis, and catalytic pyrolysis.

The first reactor (3) can be a reactor capable of gasifying the hydrocarbons constituting the plastic in an environment which can be substantially free of oxygen or can contain less oxygen relative to ambient air, whereby illustrative examples can include, but are not limited to, a pyrolysis furnace, a fluidized-bed pyrolysis reactor, a fixed-bed pyrolysis reactor, a vacuum pyrolysis reactor (which can operate at a negative pressure), a circulating reactor, an ablative pyrolysis reactor, an auger or screw pyrolysis reactor, a rotary-kiln pyrolysis reactor, a drum pyrolysis reactor, a tubular pyrolysis reactor, a heinz retort pyrolysis reactor, a vortex pyrolysis reactor, an entrained-flow pyrolysis reactor, a wire mesh pyrolysis reactor, a batch pyrolysis reactor, a semi-batch reactor pyrolysis reactor, an induction furnace, an electric resistance furnace, an electric arc furnace, or the like.

The output of the first reactor (3) can comprise gaseous hydrocarbons of varying compositions. Subsequently, the present method can further include introducing a feedstock comprising, consisting essentially of, or consisting of at least a portion of the gaseous hydrocarbons generated within the first reactor (3) into a second reactor (4) in which the gaseous hydrocarbons (which comprise hydrogen and carbon) can be heated to a high temperature to separate the hydrogen and the carbon. Additional byproducts may also be separated via the high-temperature heating, depending upon the composition of the plastic feedstock, but for the sake of simplicity and brevity, are not presently discussed.

The first and second reactors (3, 4) can be co-located, integrated, and/or fluidically coupled or connected to permit transfer of the gaseous hydrocarbons from the first reactor (3) to the second reactor (4), such as via a travel path. For example, the travel path can comprise a conduit and/or valves and/or the like disposed between a first reactor (3) outlet and a second reactor (4) inlet through which the gaseous hydrocarbons can travel, such as under the influence of a pressure gradient and/or the upward flow (or rising) of hot gas, for introduction into the second reactor (4).

As to particular embodiments, the gaseous hydrocarbons can be transferred from the first reactor (3) to the second reactor (4) without substantially any cooling and/or condensation. Accordingly, as to particular embodiments, the travel path can be sufficiently insulated and/or heated to facilitate substantial maintenance of the temperature of the gaseous hydrocarbons from the first reactor (3) to the second reactor (4). Hence, a first reactor (3) output temperature of the gaseous hydrocarbons can be substantially the same as a second reactor (4) input temperature of the gaseous hydrocarbons. As but one example, if the gaseous hydrocarbons are output from the first reactor (3) at a temperature of about 400° C., then said gaseous hydrocarbons can be input into the second reactor (4) at a temperature of about 400° C. As another example, if the gaseous hydrocarbons are output from the first reactor (3) at a temperature of about 1,000° C., then said gaseous hydrocarbons can be input into the second reactor (4) at a temperature of about 1,000° C. As to particular embodiments, the gaseous hydrocarbons can decrease in temperature by no more than 75%, no more than 70%, no more than 65%, no more than 60%, no more than 55%, no more than 50%, no more than 45%, no more than 40%, no more than 35%, no more than 30%, no more than 25%, no more than 20%, no more than 15%, no more than 10%, or no more than 5%, depending upon the embodiment, from the first reactor (3) to the second reactor (4). As but one example, if the gaseous hydrocarbons are output from the first reactor (3) at a temperature of about 400° C., then said gaseous hydrocarbons can be input into the second reactor (4) at a temperature of not less than about 300° C.; thus, the gaseous hydrocarbons decreased in temperature from the first reactor (3) to the second reactor (4) by no more than 25%.

In the second reactor (4), the gaseous hydrocarbons can be heated to a temperature which exceeds the dissociation temperature of the molecules comprising the gaseous hydrocarbons, thereby breaking the chemical bonds within the molecules to separate their constituents, correspondingly breaking the molecules down into smaller/simpler components and/or their constituent atoms, elements, or ions. Specifically, as to particular embodiments, thermal dissociation of the gaseous hydrocarbons can generate hydrogen atoms and carbon atoms. Said another way, the gaseous hydrocarbons can be cracked to generate hydrogen atoms and carbon atoms. Ultimately, the hydrogen atoms may, but need not necessarily, combine to form gaseous hydrogen (H₂) and the carbon may, but need not necessarily, solidify into carbon black.

Akin to the first reactor (3), as to particular embodiments, the second reactor (4) can be gastight and the environment therewithin (in which the thermal dissociation reaction takes place) can be substantially free of oxygen or can contain less oxygen relative to ambient air. For example, the environment within the second reactor (4) can comprise not more than 20% oxygen by weight, not more than 17.5% oxygen by weight, not more than 15% oxygen by weight, not more than 12.5% oxygen by weight, not more than 10% oxygen by weight, not more than 7.5% oxygen by weight, not more than 5% oxygen by weight, not more than 2.5% oxygen by weight, or not more than 1% oxygen by weight, depending upon the embodiment.

Of note, as the second reactor (4) can be substantially free of oxygen, there may be no combustion process(es) occurring therewithin to produce the pollutants normally expected from incinerators, such as greenhouse gases.

Again akin to the first reactor (3), as to particular embodiments, the environment within the gastight second reactor (4) can comprise primarily one or more inert gases, such as nitrogen, argon, helium, any gas that does not comprise oxygen, or any non-oxygen-carrying gas. As to particular embodiments, the environment within the gastight second reactor (4) can comprise primarily inert gas. For example, the environment within the second reactor (4) can comprise not less than 100% inert gas by weight, not less than 99% inert gas by weight, not less than 95% inert gas by weight, not less than 90% inert gas by weight, not less than 85% inert gas by weight, not less than 80% inert gas by weight, not less than 75% inert gas by weight, not less than 70% inert gas by weight, not less than 65% inert gas by weight, not less than 60% inert gas by weight, not less than 55% inert gas by weight, not less than 50% inert gas by weight, not less than 45% inert gas by weight, not less than 40% inert gas by weight, not less than 35% inert gas by weight, not less than 30% inert gas by weight, not less than 25% inert gas by weight, not less than 20% inert gas by weight, not less than 15% inert gas by weight, not less than 10% inert gas by weight, not less than 5% inert gas by weight, not less than 1% inert gas by weight, or not less than 0% inert gas by weight, depending upon the embodiment. The inert gas can be fed into the second reactor (4) via an inert gas inlet. As to particular embodiments, the inert gas inlet can be fluidically coupled to an inert gas source. As to particular embodiments including nitrogen as an inert gas, the inert gas inlet can be fluidically coupled to a nitrogen tank, which can be supplied by a nitrogen generator that can separate nitrogen gas from atmospheric air. As to particular embodiments, the first reactor (3) and the second reactor (4) can be supplied by the same inert gas source.

Thermal dissociation occurs at high temperatures; hence, the thermal dissociation reaction performed in the second reactor (4) can be carried out at a temperature of between about 3,750° C. and about 12,500° C. As to particular embodiments, the thermal dissociation reaction performed in the second reactor (4) can be carried out at a temperature of between about 5,000° C. and about 10,000° C. As to particular embodiments, the thermal dissociation reaction performed in the second reactor (4) can be carried out at a temperature of not less than about 5,000° C., not less than about 6,000° C., not less than about 7,000° C., not less than about 8,000° C., not less than about 9,000° C., or not less than about 10,000° C., depending upon the embodiment. As to particular embodiments, the thermal dissociation reaction performed in the second reactor (4) can be carried out at a temperature of not greater than about 5,000° C., not greater than about 6,000° C., not greater than about 7,000° C., not greater than about 8,000° C., not greater than about 9,000° C., or not greater than about 10,000° C., depending upon the embodiment. Naturally, the temperature can be adjusted to facilitate the production of a desired end product(s).

As to particular embodiments, the thermal dissociation reaction performed in the second reactor (4) can be carried out at an operating pressure of between about 0 psi and about 750 psi. As to particular embodiments, the thermal dissociation reaction performed in the second reactor (4) can be carried out at an operating pressure of between about 0 psi and about 150 psi. As to particular embodiments, the thermal dissociation reaction performed in the second reactor (4) can be carried out at an operating pressure of between about 37.5 psi and about 250 psi. As to particular embodiments, the thermal dissociation reaction performed in the second reactor (4) can be carried out at an operating pressure of between about 50 psi and about 200 psi. As to particular embodiments, the thermal dissociation reaction performed in the second reactor (4) can be carried out at an operating pressure of between about 112.5 psi and about 750 psi. As to particular embodiments, the thermal dissociation reaction performed in the second reactor (4) can be carried out at an operating pressure of between about 150 psi and about 600 psi. As to particular embodiments, the thermal dissociation reaction performed in the second reactor (4) can be carried out at an operating pressure of not less than about 0 psi, not less than about 37.5 psi, not less than about 50 psi, not less than about 100 psi, not less than about 150 psi, not less than about 200 psi, not less than about 250 psi, not less than about 300 psi, not less than about 350 psi, not less than about 400 psi, not less than about 450 psi, not less than about 500 psi, not less than about 550 psi, not less than about 600 psi, not less than about 650 psi, not less than about 700 psi, or not less than about 750 psi, depending upon the embodiment. As to particular embodiments, the thermal dissociation reaction performed in the second reactor (4) can be carried out at an operating pressure of not greater than about 0 psi, not greater than about 37.5 psi, not greater than about 50 psi, not greater than about 100 psi, not greater than about 150 psi, not greater than about 200 psi, not greater than about 250 psi, not greater than about 300 psi, not greater than about 350 psi, not greater than about 400 psi, not greater than about 450 psi, not greater than about 500 psi, not greater than about 550 psi, not greater than about 600 psi, not greater than about 650 psi, not greater than about 700 psi, or not greater than about 750 psi, depending upon the embodiment. Naturally, the pressure can be adjusted to facilitate the production of a desired end product(s). As to particular embodiments, the pressure within the second reactor (4) can function, at least in part, to keep air out of the second reactor (4) and/or generate a pressure gradient to transfer the heated hydrogen into a subsequent process component(s), such as a third reactor (6).

As to particular embodiments, the thermal dissociation reaction performed in the second reactor (4) can be carried out in the absence of a catalyst. As to other particular embodiments, the thermal dissociation reaction performed in the second reactor (4) can be carried out in the presence of a catalyst.

As to particular embodiments, the first reactor (3) and the second reactor (4) may be combined into a single process component which can pyrolyze plastic feedstock to gasify its hydrocarbons and thermally dissociate the gaseous hydrocarbons to generate hydrogen atoms and carbon atoms, whereby one power supply can provide the energy for both reactions. As to other particular embodiments, the first reactor (3) and the second reactor (4) may be housed together. As to yet other particular embodiments, the first reactor (3) and the second reactor (4) may be discrete process components fluidically coupled or connected together.

The second reactor (4) can be a reactor capable of achieving the above-detailed high temperatures to thermally dissociate gaseous hydrocarbons into hydrogen atoms and carbon atoms. As to particular embodiments, the second reactor (4) can comprise an electric arc (7). As to particular embodiments, the second reactor (4) can be configured as an electric arc furnace (which may utilize graphite electrodes) or a plasma arc furnace comprising one or more plasma torches (8) (or plasma nozzles or plasma zones) which can generate a directed flow of plasma (9).

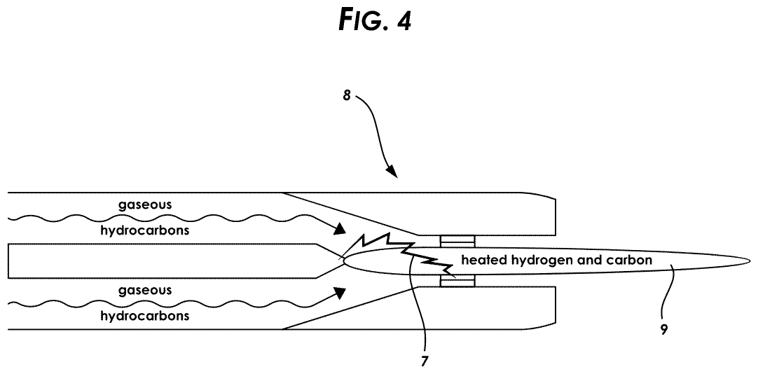

Now referring primarily to FIG. 4, as per the present invention, the gaseous hydrocarbon feedstock can be input into one or more plasma torches (8) which can excite the gaseous hydrocarbon molecules using electricity, resulting in a super-heated gas beyond that obtainable by conventional heating processes. Within the plasma torch (8), the gaseous hydrocarbons can be flowed or passed through an electric arc (7) generated between electrodes (whether consumable or non-consumable) and specifically, between a cathode and an anode, via the application of a voltage which induces current to flow between the cathode and the anode. The intense energy of the electric arc (7) can cause the constituent molecules and atoms of the gaseous hydrocarbons to dissociate from one another (via bond breaking), consequently generating hydrogen atoms and carbon atoms.

As a plasma torch (8) can generate extremely high temperatures, as per convention, a cooling system may be implemented to control the operating temperature thereof and/or cool one or more components thereof to prevent overheating. As to particular embodiments, the cooling system can comprise gas cooling or use gas as a cooling fluid. As to particular embodiments, the cooling gas can comprise, consist essentially of, or consist of an inert gas, such as nitrogen, argon, helium, etc.

Again referring primarily to FIG. 4, the temperature of the hydrogen atoms and, upon combination, hydrogen gas (H₂) generated via the electric arc (7) can be high and correspondingly, the generated hydrogen can be referred to herein as heated hydrogen. As to particular embodiments, heated hydrogen can have a temperature of not less than about 500° C., not less than about 600° C., not less than about 700° C., not less than about 800° C., not less than about 900° C., not less than about 1,000° C., not less than about 2,000° C., not less than about 3,000° C., not less than about 4,000° C., not less than about 5,000° C., not less than about 6,000° C., not less than about 7,000° C., not less than about 8,000° C., not less than about 9,000° C., or not less than about 10,000° C., depending upon the embodiment.

Following thermal dissociation, the heated hydrogen can subsequently be separated from the carbon, whereby separation can be accomplished by various means and, as to particular embodiments, within a hydrogen separator. As but one illustrative example, separation can be facilitated by the upward flow of lighter heated hydrogen and the downward flow of heavier solidified carbon. As but another illustrative example, separation can be facilitated by a membrane (or filter) which allows the heated hydrogen to pass therethrough while precluding the passage of carbon and other gases. Such membranes can include, but are not limited to, polymeric membranes, metal membranes (for example palladium (Pd) membranes, palladium alloy membranes, stainless steel membranes, vanadium membranes, nickel membranes, or the like), ceramic membranes (for example, mixed ionic-electronic conducting (MIEC) membranes, perovskite-type membranes, or the like), and carbon-based membranes (for example, carbon fiber membranes, graphene membranes, carbon nanotube (CNT) membranes, or the like). As but another illustrative example, separation can be facilitated by the application of a charge(s); for example, a negative charge may attract the heated hydrogen and a positive charge may repel the heated hydrogen and/or attract carbon, whereby the attracting and/or repelling forces can direct the flow of the heated hydrogen for separation thereof.

Of note, thermal dissociation is reversible, meaning upon cooling, the dissociated atoms can combine with one another to form molecules/compounds, whether the original molecules/compounds or new molecules/compounds. Consequently, as to particular embodiments, the present method can further include, after the separation of the heated hydrogen, relatively rapidly cooling (quenching) the byproducts of the thermal dissociation reaction to minimize the opportunity for (i) residual hydrogen, nitrogen, oxygen, and carbon to participate in combinatorial chemical reactions, and (ii) undesirable or poisonous molecules/compounds to form, such as cyanides, isocyanates, nitrogen oxides, etc.

The output of the second reactor (4) can comprise heated hydrogen, which may take the form of heated hydrogen atoms and/or heated hydrogen molecules (H₂). Subsequently, the present method can further include introducing a feedstock comprising, consisting essentially of, or consisting of at least a portion of the heated hydrogen generated within the second reactor (4) into a third reactor (6) in which the heated hydrogen can be combined with nitrogen to generate ammonia via an ammonia generation reaction. Said another way, the heated hydrogen can react with nitrogen to generate ammonia via an ammonia generation reaction.

The second and third reactors (4, 6) can be co-located, integrated, and/or fluidically coupled or connected to permit transfer of the heated hydrogen from the second reactor (4) to the third reactor (6), such as via a travel path. For example, the travel path can comprise a conduit and/or valves and/or the like disposed between a second reactor (4) outlet and a third reactor (6) inlet through which the heated hydrogen can travel, such as under the influence of a pressure gradient and/or the upward flow (or rising) of hot gas, for introduction into the third reactor (6).

As to particular embodiments, the second and third reactors (4, 6) can be co-located, integrated, and/or fluidically coupled with the hydrogen separator disposed therebetween. Following, the heated hydrogen can be transferred from the second reactor (4) to the third reactor (6) via a travel path which includes the hydrogen separator and correspondingly, the travel path can comprise a conduit and/or valves and/or the like disposed between the second reactor (4) outlet, the hydrogen separator, and the third reactor (6) inlet through which the heated hydrogen can travel, such as under the influence of a pressure gradient and/or the upward flow (or rising) of hot gas, for introduction into the third reactor (6).

As to particular embodiments, importantly, the heated hydrogen can be transferred from the second reactor (4) to the third reactor (6) without decreasing the temperature of the heated hydrogen (“heated hydrogen temperature”) to less than the temperature required for the ammonia generation reaction (“ammonia generation reaction temperature”). Said another way, the heated hydrogen can be input into the third reactor (6) at a heated hydrogen temperature of not less than the ammonia generation reaction temperature. Said yet another way, the heated hydrogen can be input into the third reactor (6) at a heated hydrogen temperature which is equal to or greater than the ammonia generation reaction temperature. Accordingly, as to particular embodiments, the travel path can be sufficiently insulated and/or heated to preclude the heated hydrogen temperature from decreasing to less than the ammonia generation reaction temperature.

As to particular embodiments, in the third reactor (6), the heated hydrogen can react with nitrogen (N₂) in the presence of a catalyst to synthesize ammonia (NH₃), as follows:

N₂+3H₂→2NH₃

As to particular embodiments, the ammonia generation reaction performed in the third reactor (6) can be carried out at a temperature of between about 375° C. and about 1,000° C. As to particular embodiments, the ammonia generation reaction performed in the third reactor (6) can be carried out at a temperature of between about 500° C. and about 800° C. As to particular embodiments, the ammonia generation reaction performed in the third reactor (6) can be carried out at a temperature of not less than about 500° C., not less than about 550° C., not less than about 600° C., not less than about 650° C., not less than about 700° C., not less than about 750° C., not less than about 800° C., not less than about 850° C., not less than about 900° C., not less than about 950° C., or not less than about 1,000° C., depending upon the embodiment. As to particular embodiments, the ammonia generation reaction performed in the third reactor (6) can be carried out at a temperature of not greater than about 500° C., not greater than about 550° C., not greater than about 600° C., not greater than about 650° C., not greater than about 700° C., not greater than about 750° C., not greater than about 800° C., not greater than about 850° C., not greater than about 900° C., not greater than about 950° C., or not greater than about 1,000° C., depending upon the embodiment. Naturally, the temperature can be adjusted to facilitate the production of a desired end product(s).

As detailed above, significantly, the heated hydrogen can be transferred from the second reactor (4) to the third reactor (6) without decreasing the temperature of the heated hydrogen to less than the temperature required for the ammonia generation reaction. Correspondingly, as to particular embodiments, upon input into the third reactor (6), the heated hydrogen can have a temperature of not less than about 500° C., not less than about 550° C., not less than about 600° C., not less than about 650° C., not less than about 700° C., not less than about 750° C., not less than about 800° C., not less than about 850° C., not less than about 900° C., not less than about 950° C., or not less than about 1,000° C., depending upon the embodiment.

Notably, as to particular embodiments, the heated hydrogen can provide sufficient heat to achieve the temperature required for the ammonia generation reaction, which can mean that no external energy is needed for the ammonia generation reaction and therefore, no external energy needs be provided to the third reactor (6). As to particular embodiments, the heated hydrogen can provide sufficient heat to heat the nitrogen used for the ammonia generation reaction to the temperature required for the ammonia generation reaction.

As to particular embodiments, the ammonia generation reaction performed in the third reactor (6) can be carried out at an operating pressure of between about 75 psi and about 4,000 psi, whereby the operating pressure may be dependent, at least in part, on the catalyst used to synthesize the ammonia. As to particular embodiments, the ammonia generation reaction performed in the third reactor (6) can be carried out at an operating pressure of between about 100 psi and about 3000 psi. As to particular embodiments, the ammonia generation reaction performed in the third reactor (6) can be carried out at an operating pressure of not less than about 100 psi, not less than about 500 psi, not less than about 1,000 psi, not less than about 1,500 psi, not less than about 2,000 psi, not less than about 2,500 psi, or not less than about 3,000 psi, depending upon the embodiment. As to particular embodiments, the ammonia generation reaction performed in the third reactor (6) can be carried out at an operating pressure of not greater than about 100 psi, not greater than about 500 psi, not greater than about 1,000 psi, not greater than about 1,500 psi, not greater than about 2,000 psi, not greater than about 2,500 psi, or not greater than about 3,000 psi, depending upon the embodiment. Naturally, the pressure can be adjusted to facilitate the production of a desired end product(s).

As to other particular embodiments, the ammonia generation reaction performed in the third reactor (6) can be carried out at an operating pressure of not greater than about 100 psi, not greater than about 75 psi, not greater than about 50 psi, not greater than about 25 psi, or not greater than atmospheric pressure (which can be about 14.7 psi at sea level) or the pressure of the ambient air, depending upon the embodiment.

As stated above, as to particular embodiments, in the third reactor (6), the heated hydrogen can be reacted with nitrogen (N₂) in the presence of a catalyst to synthesize ammonia (NH₃). As to particular embodiments, the catalyst can be a metal catalyst. As to particular embodiments, the catalyst can be iron.

As to particular embodiments, the heated hydrogen can be reacted with nitrogen (N₂) in the presence of a catalyst to synthesize ammonia (NH₃) as per the Haber-Bosch process, developed by German chemists Fritz Haber and Carl Bosch in the first decade of the 20th century, or variations thereof.

As to particular embodiments, the ammonia generation reaction can be exothermic, meaning it can release heat. At least a portion of this thermal energy can be recycled back into the present method, such as via a heat exchanger. As but one illustrative example, a heat exchanger can transfer at least a portion of the thermal energy generated by the ammonia generation reaction to heat the nitrogen used for the ammonia generation reaction; as to particular embodiments, the thermal energy can be sufficient to heat said nitrogen to the temperature required for the ammonia generation reaction.

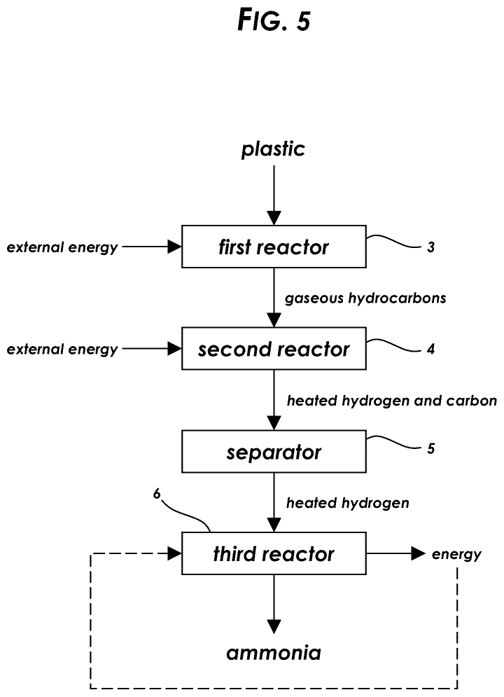

Now referring primarily to FIG. 5, regarding energy, as to particular embodiments, the present (i) pyrolysis of the plastic feedstock carried out in the first reactor (3) and (ii) thermal dissociation of the gaseous hydrocarbon feedstock carried out in the second reactor (4) can be powered by external energy. As to particular embodiments, at least a portion of the external energy provided to the first reactor (3) and/or the second reactor (4) can be electric energy (such as via an alternating current (AC) power supply or a direct current (DC) power supply) from a non-fossil fuel-based electricity source(s). As to particular embodiments, at least 50%, at least 60%, at least 70%, at least 80%, at least 90%, at least 95%, at least 99%, or 100% of the total amount of energy provided to the first reactor (3) and/or the second reactor (4) can be directly or indirectly from electric energy from a non-fossil fuel-based electricity source(s), depending upon the embodiment. Advantageously, relative to fossil fuel-fired reactors, the present first reactor (3) and/or second reactor (4) may discharge a lesser amount of greenhouse gases.

As to particular embodiments, at least a portion of the external energy provided to the first reactor (3) and/or the second reactor (4) can be energy from a renewable energy source(s) (as opposed to a nonrenewable energy source, such as fossil fuels). As to particular embodiments, at least 50%, at least 60%, at least 70%, at least 80%, at least 90%, at least 95%, at least 99%, or 100% of the total amount of energy provided to the first reactor (3) and/or the second reactor (4) can be directly or indirectly from a renewable energy source(s), depending upon the embodiment.

The ammonia output from the third reactor (6) can be cooled and compressed to form liquid ammonia, which can subsequently be stored and/or used for various industrial, agricultural, and commercial applications, such as, but not limited to, the following.

Fuel and Energy Storage: Ammonia made from renewable energy has the potential to be used as a renewable fuel. It can be used as a hydrogen carrier or as a direct fuel in combustion engines.

Fuel Cells: Ammonia can be used as a source of hydrogen in fuel cells, which can generate electricity with water vapor as the only byproduct.

Fertilizer Production: Ammonia is a crucial component in the production of nitrogen-based fertilizers, such as ammonium nitrate and urea. These fertilizers provide essential nutrients for plant growth.

Refrigeration and Air Conditioning: Ammonia is used as a refrigerant in industrial refrigeration systems, cold storage facilities, and ice-making plants. It is also used in some large-scale air conditioning systems.

Cleaning and Disinfection: Ammonia-based cleaning products are widely used for household and industrial cleaning purposes. Ammonia is an effective degreaser, stain remover, and disinfectant.

pH Control: In various industrial processes, ammonia is used to control pH levels in solutions. It acts as a buffering agent, helping to stabilize the acidity or alkalinity of a solution.

Water Treatment: Ammonia is used in water treatment processes to remove contaminants like chlorine and chloramines. It reacts with these compounds to form harmless byproducts.

Textile Industry: Ammonia is used in textile manufacturing processes, including dyeing and printing. It helps fix dyes to the fabric and acts as a mordant.

Explosives and Pyrotechnics: Ammonia is a key ingredient in the production of explosives like ammonium nitrate-based explosives. It is also used in certain types of fireworks.

Pharmaceuticals and Chemicals: Ammonia and its derivatives are used in the production of pharmaceuticals, including antibiotics, vitamins, and other medicines. It is also a precursor for various chemical reactions.

Metallurgical Processes: In steel production, ammonia is used to remove impurities from the raw iron ore during the refining process. It helps produce high-quality steel.

Animal Feed Additive: Ammonia is used as an additive in animal feeds to provide a source of nitrogen and improve the nutritional value of the feed.

Healthcare: Ammonia solutions are used in medical applications, such as in the treatment of certain respiratory conditions or as a smelling salt to revive individuals who have fainted.

As to particular embodiments, the present method can be performed on a commercial scale. Accordingly, one or more, or all, of the process components can be configured for use in a commercial scale processing facility or plant. For example, as to particular embodiments, the processing facility can intake mixed plastic waste at an average feed rate of about 100 tons per day, and can output about 60 to 68 tons of ammonia per day. Significantly, the processing facility can operate substantially continuously, which can result in the elimination of about 36,500 tons of plastic waste per year, and the corresponding production of about 21,900 to about 24,820 tons of ammonia per year.

To achieve the above input and output rates, as an illustrative example, the first reactor (3) can have a continuous mass flow of about 4,000 kilograms per hour. With subtractions (for example due to first reactor (3) byproducts) and additions (such as the addition of inert gas), the second reactor (4) can have a continuous mass flow of about 3,800 kilograms per hour. Again with subtractions (for example due to second reactor (4) byproducts) and additions (such as the addition of nitrogen), the third reactor (6) can have a continuous mass flow of about 2,500 kilograms per hour.

As to particular embodiments, the first, second, and/or third reactor (3, 4, 6) can include a cleaning feature which can facilitate the removal of solid byproducts that can accumulate in the reaction chamber during operation of the reactor. The cleaning feature may make it possible to prevent or at least reduce any disruptive influence of the solid byproducts on the reaction.

As to particular embodiments, the first, second, and/or third reactor (3, 4, 6) can be operatively coupled to a pump for adjusting the pressure in the reaction chamber(s).

As to particular embodiments, the first, second, and/or third reactor (3, 4, 6) can be operatively coupled to an inert gas source or a tank of pressurized inert gas for adjusting the pressure in the reaction chamber(s).

As to particular embodiments, the first, second, and/or third reactor (3, 4, 6) can include one or more analysis devices for analyzing method parameters, such as, but not limited to, the composition of the gas flows that are fed into or output from a reactor, and or the byproducts produced in a reactor.

Where a method component (for example, a reactor, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods, and apparatus have been described herein for the purpose of illustration. These are only examples. The technology provided herein can be applied to systems other than the example systems described above. Many alterations, modifications, additions, omissions, and permutations are possible within the practice of this invention. This invention includes variations on described embodiments that would be apparent to a person of ordinary skill in the art, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “particular embodiments.” Such features are not mandatory and may not be present in all embodiments. Embodiments of the invention may include zero, any one, or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “particular embodiments” possess feature A and “particular embodiments” possess feature B should be interpreted as an express indication that the inventors also contemplate embodiments which combine features A and B (unless the description states otherwise or features A and B are fundamentally incompatible).

Further embodiments of the present disclosure include the following examples.

Example 1. A method of making ammonia from plastic, comprising:
heating said plastic comprising hydrocarbons to gasify said hydrocarbons and generate gaseous hydrocarbons comprising hydrogen and carbon;
heating said gaseous hydrocarbons to separate said hydrogen and said carbon and generate heated hydrogen; and
combining said heated hydrogen with nitrogen to generate ammonia.

Example 2. The method of Example 1, wherein said plastic comprises plastic waste.

Example 3. The method of any one of Examples 1-2, wherein said plastic comprises mixed plastic waste.

Example 4. The method of any one of the preceding Examples, wherein said plastic comprises unsorted plastic waste.

Example 5. The method of any one of the preceding Examples, wherein said plastic can be contaminated with contaminants.

Example 6. The method of Example 5, wherein said contaminants comprise one or more of paper, water, biomass, food waste, glass, metal, dirt, sand, a colorant, a filler, or a plasticizer additive.

Example 7. The method of any one of the preceding Examples, further comprising reducing the size of said plastic prior to said heating of said plastic to generate said gaseous hydrocarbons.

Example 8. The method of any one of the preceding Examples, further comprising shredding said plastic prior to said heating of said plastic to generate said gaseous hydrocarbons.

Example 9. The method of any one of the preceding Examples, further comprising compacting said plastic prior to said heating of said plastic to generate said gaseous hydrocarbons.

Example 10. The method of any one of the preceding Examples, further comprising extruding said plastic prior to said heating of said plastic to generate said gaseous hydrocarbons.

Example 11. The method of any one of the preceding Examples, further comprising (i) reducing the size of and (ii) compacting said plastic prior to said heating of said plastic to generate said gaseous hydrocarbons.

Example 12. The method of any one of the preceding Examples, further comprising heating said plastic to a high temperature in the substantial absence of oxygen to generate said gaseous hydrocarbons.

Example 13. The method of any one of the preceding Examples, further comprising pyrolyzing said plastic to generate said gaseous hydrocarbons.

Example 14. The method of any one of the preceding Examples, further comprising subjecting said plastic to pyrolysis to generate said gaseous hydrocarbons.

Example 15. The method of any one of the preceding Examples, further comprising generating said gaseous hydrocarbons within a first reactor.

Example 16. The method of Example 15, wherein the environment within said first reactor comprises primarily inert gas.

Example 17. The method of any one of Examples 15-16, wherein an inert gas source is fluidically coupled to said first reactor to provide said inert gas.

Example 18. The method of any one of Examples 15-17, wherein the environment not including said gaseous hydrocarbons within said first reactor comprises primarily inert gas.

Example 19. The method of any one of Examples 15-18, further comprising heating said plastic to a temperature of between about 300° C. and about 1,250° C. within said first reactor to generate said gaseous hydrocarbons.

Example 20. The method of any one of Examples 15-19, further comprising operating said first reactor at a pressure of between about 50 psi and about 200 psi to generate said gaseous hydrocarbons.

Example 21. The method of any one of Examples 15-20, further comprising operating said first reactor at a pressure of between about 150 psi and about 600 psi to keep air out of said first reactor and push said gaseous hydrocarbons to a second reactor.

Example 22. The method of any one of Examples 15-21, further comprising providing external energy from one or more non-fossil fuel-based electricity sources to said first reactor to heat said plastic to generate said gaseous hydrocarbons.

Example 23. The method of any one of Examples 15-22, further comprising providing external energy from one or more renewable energy sources to said first reactor to heat said plastic to generate said gaseous hydrocarbons.

Example 24. The method of any one of Examples 15-23, wherein said first reactor comprises a gasification apparatus.

Example 25. The method of any one of Examples 15-24, further comprising transferring said gaseous hydrocarbons from said first reactor to a fluidically coupled second reactor in which said heating of said gaseous hydrocarbons to separate said hydrogen and said carbon and generate said heated hydrogen is carried out.

Example 26. The method of Example 25, further comprising transferring said gaseous hydrocarbons from said first reactor to said second reactor without substantially any cooling and/or condensation of said gaseous hydrocarbons.

Example 27. The method of any one of Examples 25-26, wherein the temperature of said gaseous hydrocarbons is substantially maintained during transfer of said gaseous hydrocarbons from said first reactor to said second reactor.

Example 28. The method of any one of Examples 25-27, wherein a first reactor output temperature of said gaseous hydrocarbons is substantially the same as a second reactor input temperature of said gaseous hydrocarbons.

Example 29. The method of any one of Examples 25-28, wherein said gaseous hydrocarbons decrease in temperature by no more than 75% during transfer of said gaseous hydrocarbons from said first reactor to said second reactor.

Example 30. The method of any one of Examples 25-29, further comprising heating said gaseous hydrocarbons to a high temperature in the substantial absence of oxygen to separate said hydrogen and said carbon and generate said heated hydrogen within said second reactor.

Example 31. The method of any one of Examples 25-30, further comprising heating said gaseous hydrocarbons to a high temperature in the substantial absence of oxygen to dissociate said hydrogen and said carbon and generate said heated hydrogen within said second reactor.

Example 32. The method of any one of Examples 25-31, wherein the environment within said second reactor comprises primarily inert gas.

Example 33. The method of Example 32, wherein an inert gas source is fluidically coupled to said second reactor to provide said inert gas.

Example 34. The method of any one of Examples 25-33, further comprising heating said gaseous hydrocarbons to a temperature of between about 3,750° C. and about 12,500° C. within said second reactor to thermally dissociate said hydrogen and said carbon and generate said heated hydrogen.

Example 35. The method of any one of Examples 25-34, further comprising heating said gaseous hydrocarbons to a temperature of between about 5,000° C. and about 10,000° C. within said second reactor to thermally dissociate said gaseous hydrocarbons into said hydrogen and said carbon and generate said heated hydrogen.

Example 36. The method of any one of Examples 25-35, further comprising operating said second reactor at a pressure of between about 100 psi and about 500 psi to thermally dissociate said hydrogen and said carbon and generate said heated hydrogen.

Example 37. The method of any one of Examples 25-36, further comprising operating said second reactor at a pressure of between about 100 psi and about 500 psi to keep air out of said second reactor and push said heated hydrogen to a third reactor.

Example 38. The method of any one of Examples 25-37, further comprising providing external energy from one or more non-fossil fuel-based electricity sources to said second reactor to dissociate said hydrogen and said carbon and generate said heated hydrogen.

Example 39. The method of any one of Examples 25-38, further comprising providing external energy from one or more non-fossil fuel-based electricity sources to said second reactor to dissociate said gaseous hydrocarbons into hydrogen and said carbon and generate said heated hydrogen.

Example 40. The method of any one of Examples 25-39, further comprising providing external energy from one or more renewable energy sources to said second reactor to dissociate said hydrogen and said carbon and generate said heated hydrogen.

Example 41. The method of any one of Examples 25-40, further comprising providing external energy from one or more renewable energy sources to said second reactor to dissociate said gaseous hydrocarbons into said hydrogen and said carbon and generate said heated hydrogen.

Example 42. The method of any one of Examples 25-41, wherein said second reactor comprises an electric arc.

Example 43. The method of Example 42, further comprising flowing said gaseous hydrocarbons through said electric arc to dissociate said hydrogen and said carbon and generate said heated hydrogen.

Example 44. The method of any one of Examples 42-43, further comprising flowing all the gases from said first reactor through said electric arc to dissociate said gaseous hydrocarbons into said hydrogen and said carbon and generate said heated hydrogen.

Example 45. The method of any one of Examples 25-44, wherein said second reactor comprises a plasma torch.

Example 46. The method of Example 45, further comprising providing a cooling gas to said plasma torch.

Example 47. The method of Example 46, wherein said cooling gas comprises inert gas.

Example 48. The method of any one of Examples 25-47, wherein said second reactor comprises a plasma torch, a plasma nozzle, a plasma zone, or a plasma plume through which all the gases from said first reactor must flow.

Example 49. The method of Example 48, further comprising providing a cooling gas to said plasma torch, said plasma nozzle, said plasma zone, or said plasma plume.

Example 50. The method of Example 49, wherein said cooling gas comprises inert gas.

Example 51. The method of any one of Examples 25-50, wherein said heated hydrogen has a temperature of not less than about 500° C.

Example 52. The method of any one of Examples 25-51, wherein said heated hydrogen has a temperature of not less than about 600° C.

Example 53. The method of any one of Examples 25-52, wherein said heated hydrogen has a temperature of not less than about 700° C.

Example 54. The method of any one of Examples 25-53, wherein said heated hydrogen has a temperature of not less than about 800° C.

Example 55. The method of any one of Examples 25-54, wherein said heated hydrogen has a temperature of not less than about 900° C.

Example 56. The method of any one of Examples 25-55, wherein said heated hydrogen has a temperature of not less than about 1,000° C.

Example 57. The method of any one of Examples 25-56, wherein said heated hydrogen has a temperature of not less than about 2,000° C.

Example 58. The method of any one of Examples 25-57, wherein said heated hydrogen has a temperature of not less than about 3,000° C.

Example 59. The method of any one of Examples 25-58, wherein said heated hydrogen has a temperature of not less than about 4,000° C.

Example 60. The method of any one of Examples 25-59, wherein said heated hydrogen has a temperature of not less than about 5,000° C.

Example 61. The method of any one of Examples 25-60, wherein said heated hydrogen has a temperature of not less than about 6,000° C.

Example 62. The method of any one of Examples 25-61, wherein said heated hydrogen has a temperature of not less than about 7,000° C.

Example 63. The method of any one of Examples 25-62, wherein said heated hydrogen has a temperature of not less than about 8,000° C.

Example 64. The method of any one of Examples 25-63, wherein said heated hydrogen has a temperature of not less than about 9,000° C.

Example 65. The method of any one of Examples 25-64, wherein said heated hydrogen has a temperature of not less than about 10,000° C.

Example 66. The method of any one of Examples 25-65, wherein said heated hydrogen has a post dilution from said cooling gas temperature of not less than about 500° C.

Example 67. The method of any one of Examples 25-66, wherein said heated hydrogen has a post dilution from said cooling gas temperature of not less than about 600° C.

Example 68. The method of any one of Examples 25-67, wherein said heated hydrogen has a post dilution from said cooling gas temperature of not less than about 700° C.

Example 69. The method of any one of Examples 25-68, wherein said heated hydrogen has a post dilution from said cooling gas temperature of not less than about 800° C.

Example 70. The method of any one of Examples 25-69, wherein said heated hydrogen has a post dilution from said cooling gas temperature of not less than about 900° C.

Example 71. The method of any one of Examples 25-70, wherein said heated hydrogen has a post dilution from said cooling gas temperature of not less than about 1,000° C.

Example 72. The method of any one of Examples 25-71, further comprising separating said heated hydrogen from said carbon.

Example 73. The method of any one of Examples 25-72, further comprising separating said heated hydrogen from said carbon within a separator.

Example 74. The method of any one of Examples 25-73, further comprising separating said heated hydrogen from said carbon, and any other gases created in said second reactor.

Example 75. The method of any one of Examples 25-74, further comprising separating said heated hydrogen from said carbon, and any other gases created in said second reactor, within a separator.

Example 76. The method of any one of Examples 25-75, further comprising transferring said heated hydrogen from said second reactor to a fluidically coupled third reactor in which said combining of said heated hydrogen with said nitrogen via an ammonia generation reaction to generate said ammonia is carried out.

Example 77. The method of any one of Examples 25-76, further comprising transferring said heated hydrogen from said second reactor to a fluidically coupled third reactor in which said combining of said heated hydrogen with heated nitrogen via an ammonia generation reaction to generate said ammonia is carried out.

Example 78. The method of any one of Examples 76-77, further comprising transferring said heated hydrogen from said second reactor to said third reactor without decreasing the temperature of said heated hydrogen to less than the temperature required for said ammonia generation reaction.

Example 79. The method of any one of Examples 76-78, wherein upon input into said third reactor, said temperature of said heated hydrogen is not less than said temperature required for said ammonia generation reaction.

Example 80. The method of any one of Examples 76-79, wherein upon input into said third reactor, said temperature of said heated hydrogen is equal to or greater than said temperature required for said ammonia generation reaction.

Example 81. The method of any one of Examples 76-80, wherein upon input into said third reactor, said temperature of said heated hydrogen is not less than about 500° C.

Example 82. The method of any one of Examples 76-81, wherein upon input into said third reactor, said temperature of said heated hydrogen is not less than about 550° C.

Example 83. The method of any one of Examples 76-82, wherein upon input into said third reactor, said temperature of said heated hydrogen is not less than about 600° C.

Example 84. The method of any one of Examples 76-83, wherein upon input into said third reactor, said temperature of said heated hydrogen is not less than about 650° C.

Example 85. The method of any one of Examples 76-84, wherein upon input into said third reactor, said temperature of said heated hydrogen is not less than about 700° C.

Example 86. The method of any one of Examples 76-85, wherein upon input into said third reactor, said temperature of said heated hydrogen is not less than about 750° C.

Example 87. The method of any one of Examples 76-86, wherein upon input into said third reactor, said temperature of said heated hydrogen is not less than about 800° C.

Example 88. The method of any one of Examples 76-87, wherein upon input into said third reactor, said temperature of said heated hydrogen is not less than about 850° C.

Example 89. The method of any one of Examples 76-88, wherein upon input into said third reactor, said temperature of said heated hydrogen is not less than about 900° C.

Example 90. The method of any one of Examples 76-89, wherein upon input into said third reactor, said temperature of said heated hydrogen is not less than about 950° C.

Example 91. The method of any one of Examples 76-90, wherein upon input into said third reactor, said temperature of said heated hydrogen is not less than about 1,000° C.

Example 92. The method of any one of Examples 76-91, wherein said heated hydrogen provides sufficient heat to achieve said temperature required for said ammonia generation reaction.

Example 93. The method of any one of Examples 76-92, wherein said heated hydrogen provides sufficient heat such that no external energy is needed for said ammonia generation reaction.

Example 94. The method of any one of Examples 76-93, wherein said heated hydrogen provides sufficient heat such that no external energy needs to be provided to said third reactor.

Example 95. The method of any one of Examples 76-94, further comprising reacting said heated hydrogen with said nitrogen to generate said ammonia.

Example 96. The method of any one of Examples 76-95, wherein said ammonia generation reaction is exothermic and provides thermal energy for said method of making ammonia from plastic.

Example 97. The method of any one of Examples 76-96, wherein said ammonia generation reaction is exothermic and provides thermal energy for said reacting of said heated hydrogen with said nitrogen to generate said ammonia.

Example 98. The method of any one of Examples 76-97, further comprising forming said ammonia into liquid ammonia.

Example 99. The method of any one of Examples 76-98, further comprising storing said ammonia or using said ammonia for one or more of fuel and energy storage, fuel cells, fertilizer production, refrigeration and/or air conditioning, cleaning and/or disinfection, pH control, water treatment, textile manufacturing processes, production of explosives and pyrotechnics, production of pharmaceuticals and chemicals, metallurgical processes, production of animal feed, and medical applications.

Example 100. A system for making ammonia from plastic, comprising:
a first reactor in which said plastic comprising hydrocarbons is heated to gasify said hydrocarbons and generate gaseous hydrocarbons comprising hydrogen and carbon;
a second reactor in which said gaseous hydrocarbons are heated to separate said hydrogen and said carbon and generate heated hydrogen; and
a third reactor in which said heated hydrogen is combined with nitrogen to generate ammonia.

Example 101. The system of Example 100, further comprising a shredder in which the size of said plastic is reduced prior to said heating of said plastic to generate said gaseous hydrocarbons.

Example 102. The system of any one of Examples 100-101, further comprising an extruder in which said plastic is compacted prior to said heating of said plastic to generate said gaseous hydrocarbons.

Example 103. The system of any one of Examples 100-102, wherein the environment within said first reactor comprises primarily inert gas.

Example 104. The system of Example 103, further comprising an inert gas source fluidically coupled to said first reactor to provide said inert gas.

Example 105. The system of any one of Examples 100-104, wherein the environment not including said gaseous hydrocarbons within said first reactor comprises primarily inert gas.

Example 106. The system of any one of Examples 100-105, wherein said first reactor comprises a gasification apparatus.

Example 107. The system of any one of Examples 100-106, wherein the environment within said second reactor comprises primarily inert gas.

Example 108. The system of Example 107, further comprising an inert gas generator fluidically coupled to said second reactor to provide said inert gas.

Example 109. The system of any one of Examples 100-108, wherein the environment not including said gaseous hydrocarbons, said hydrogen, said carbon, or other gases created from the dissociation of said gaseous hydrocarbons and contamination, within said second reactor comprises primarily inert gas.

Example 110. The system of any one of Examples 100-109, wherein said second reactor comprises an electric arc.

Example 111. The system of any one of Examples 100-110, wherein said second reactor comprises a plasma torch.

Example 112. The system of any one of Examples 100-110, wherein said second reactor comprises a plasma torch, a plasma nozzle, a plasma zone, or a plasma plume through which all the gases from said first reactor must flow.

Example 113. The system of any one of Examples 100-112, further comprising a separator in which said heated hydrogen is separated from said carbon.

Example 114. The system of any one of Examples 100-113, further comprising a separator in which said heated hydrogen is separated from said carbon and other gases created from the dissociation of said gaseous hydrocarbons and contamination.

Example 115. The system of any one of Examples 100-114, wherein said heated hydrogen is reacted with said nitrogen in said third reactor.

Example 116. The system of any one of Examples 100-115, further comprising one or more heat exchangers.

Example 117. The system of any one of Examples 100-116, further comprising one or more cleaning features which can facilitate the removal of solid byproducts that can accumulate in one or more of said reactors.

Example 118. The system of any one of Examples 100-117, further comprising one or more pumps operable to adjust the pressure within one or more of said reactors.

Example 119. The system of any one of Examples 100-118, further comprising one or more inert gas sources operable to adjust the pressure within one or more of said reactors.

Example 120. The system of any one of Examples 100-119, further comprising one or more analysis devices for analyzing method parameters.

Example 121. The system of any one of Examples 100-120, wherein said reactors are configured for commercial scale operation.

Example 122. The system of any one of Examples 100-121, wherein said system inputs about 100 tons of said plastic per day.

Example 123. The system of any one of Examples 100-122, wherein said system inputs no less than about 100 tons of said plastic per day.

Example 124. The system of any one of Examples 100-123, wherein said system inputs no less than about 10 tons of said plastic per day.

Example 125. The system of any one of Examples 100-124, wherein said system inputs no less than about 1 ton of said plastic per day.

As can be easily understood from the foregoing, the basic concepts of the present invention may be embodied in a variety of ways. The invention involves numerous and varied embodiments of a system and method for making ammonia from plastic.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “reactor” should be understood to encompass disclosure of the act of “reacting”—whether explicitly discussed or not—and, conversely, were there effectively disclosure of the act of “reacting,” such a disclosure should be understood to encompass disclosure of a “reactor” and even a “means for reacting.” Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the systems and methods for making ammonia from plastic herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application, if any, provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A method of making ammonia from plastic, comprising:
heating said plastic comprising hydrocarbons to gasify said hydrocarbons and generate gaseous hydrocarbons comprising hydrogen and carbon;
heating said gaseous hydrocarbons to separate said hydrogen and said carbon and generate heated hydrogen; and
combining said heated hydrogen with nitrogen to generate ammonia.

2-12. (canceled)

13. The method of claim 1, further comprising pyrolyzing said plastic to generate said gaseous hydrocarbons.

14. (canceled)

15. The method of claim 1, further comprising generating said gaseous hydrocarbons within a first reactor.

16-24. (canceled)

25. The method of claim 15, further comprising transferring said gaseous hydrocarbons from said first reactor to a fluidically coupled second reactor in which said heating of said gaseous hydrocarbons to separate said hydrogen and said carbon and generate said heated hydrogen is carried out.

26. The method of claim 25, further comprising transferring said gaseous hydrocarbons from said first reactor to said second reactor without substantially any cooling and/or condensation of said gaseous hydrocarbons.

27-41. (canceled)

42. The method of claim 25, wherein said second reactor comprises an electric arc.

43. The method of claim 42, further comprising flowing said gaseous hydrocarbons through said electric arc to dissociate said hydrogen and said carbon and generate said heated hydrogen.

44-47. (canceled)

48. The method of claim 25, wherein said second reactor comprises a plasma torch, a plasma nozzle, a plasma zone, or a plasma plume through which all the gases from said first reactor must flow.

49-71. (canceled)

72. The method of claim 25, further comprising separating said heated hydrogen from said carbon.

73-75. (canceled)

76. The method of claim 25, further comprising transferring said heated hydrogen from said second reactor to a fluidically coupled third reactor in which said combining of said heated hydrogen with said nitrogen via an ammonia generation reaction to generate said ammonia is carried out.

77. (canceled)

78. The method of claim 76, further comprising transferring said heated hydrogen from said second reactor to said third reactor without decreasing the temperature of said heated hydrogen to less than the temperature required for said ammonia generation reaction.

79-94. (canceled)

95. The method of claim 76, further comprising reacting said heated hydrogen with said nitrogen to generate said ammonia.

96. The method of claim 76, wherein said ammonia generation reaction is exothermic and provides thermal energy for said method of making ammonia from plastic.

97. (canceled)

98. The method of claim 76, further comprising forming said ammonia into liquid ammonia.

99. The method of claim 76, further comprising storing said ammonia or using said ammonia for one or more of fuel and energy storage, fuel cells, fertilizer production, refrigeration and/or air conditioning, cleaning and/or disinfection, pH control, water treatment, textile manufacturing processes, production of explosives and pyrotechnics, production of pharmaceuticals and chemicals, metallurgical processes, production of animal feed, and medical applications.

100. A system for making ammonia from plastic, comprising:
a first reactor in which said plastic comprising hydrocarbons is heated to gasify said hydrocarbons and generate gaseous hydrocarbons comprising hydrogen and carbon;
a second reactor in which said gaseous hydrocarbons are heated to separate said hydrogen and said carbon and generate heated hydrogen; and
a third reactor in which said heated hydrogen is combined with nitrogen to generate ammonia.

101-105. (canceled)

106. The system of claim 100, wherein said first reactor comprises a gasification apparatus.

107-109. (canceled)

110. The system of claim 100, wherein said second reactor comprises an electric arc.

111. (canceled)

112. The system of claim 100, wherein said second reactor comprises a plasma torch, a plasma nozzle, a plasma zone, or a plasma plume through which all the gases from said first reactor must flow.

113-114. (canceled)

115. The system of claim 100, wherein said heated hydrogen is reacted with said nitrogen in said third reactor.

116-125. (canceled)
